(19) United States
(12) Patent Application Publication
(10) Pub. No.: US 2023/0108136 A1
(43) Pub. Date: Apr. 6, 2023

(54) DISPLAY CONTROL DEVICE AND DISPLAY CONTROL METHOD

(71) Applicant: Mitsubishi Electric Corporation, Tokyo (JP)

(72) Inventor: Takayasu HASHIMOTO, Tokyo (JP)

(73) Assignee: Mitsubishi Electric Corporation, Tokyo (JP)

(21) Appl. No.: 18/080,765

(22) Filed: Dec. 14, 2022

Related U.S. Application Data
(63) Continuation of application No. PCT/JP2020/028136, filed on Jul. 20, 2020.

(51) Int. Cl. B60K 35/00

(52) U.S. Cl. CPC B60K 35/00; B60K 2370/171; B60K 2370/48; B60K 2370/1876

(57) ABSTRACT

A display control device is formed to include a gearshift operation detecting unit to detect an operation of a gearshift of a vehicle and output gear switch information indicating a switch content of a gear position of the vehicle accompanying the operation of the gearshift, and a display control unit to acquire display data corresponding to the switch content indicated by the gear switch information output from the gearshift operation detecting unit from a display data storage unit that stores display data of an image illustrating a transition of a vehicle state when the gear position of the vehicle is switched for each of switch patterns of the gear position, and display an image on an instrument panel of the vehicle depending on the acquired display data.

### CROSS-REFERENCE TO RELATED APPLICATION

The present application is a bypass continuation of International Patent Application No. PCT/JP2020/028136, filed Jul. 20, 2020, the entire contents of which are incorporated herein by reference.

### TECHNICAL FIELD

The present disclosure relates to a display control device and a display control method.

### BACKGROUND ART

Patent Literature 1 below discloses an information display device for vehicle in which a display control unit displays a first vehicle image on a display unit in a case where a parking position P is selected by a gearshift that accepts switch of a gear position, and the display control unit displays a second vehicle image on the display unit in a case where a drive position D is selected by the gearshift.

### CITATION LIST

### Patent Literatures

Patent Literature 1: JP 2020-55354 A

### SUMMARY OF INVENTION

### Technical Problem

The information display device for vehicle disclosed in Patent Literature 1 has a problem that, even when the gear position is switched by the gearshift, it is not possible to notify a user of a transition of a vehicle state accompanying the switch.

The present disclosure has been achieved to solve the above-described problem, and an object thereof is to obtain a display control device and a display control method capable of notifying a user of a transition of a vehicle state accompanying switch of a gear position.

### Solution to Problem

A display control device according to the present disclosure includes processing circuitry to perform detection of an operation of a gearshift of a vehicle and output gear switch information indicating a switch content of a gear position of the vehicle accompanying the operation of the gearshift, and to acquire display data corresponding to the switch content indicated by the gear switch information from a display data storage that stores display data of an image illustrating a transition of a vehicle state when the gear position of the vehicle is switched for each of switch patterns of the gear position, and display an image on an instrument panel of the vehicle depending on the acquired display data. The display data stored in the display data storage includes animation data for displaying three types of graphics including a before-switching graphic indicating a state of the vehicle before switching of the gear position, an after-switching graphic indicating a state of the vehicle after switching of the gear position, and a suggestion graphic suggesting that the gear position is going to be switched to the gear position after switching of the gear position in animation, each of the three types of graphics being displayed not to overlap other two of the three types of graphics, and the processing circuitry displays each of the three types of graphics in animation depending on the animation data included in the acquired display data, and performs determination of whether the vehicle is traveling or stopping by monitoring a speed of the vehicle, wherein the processing circuitry displays each of the three types of graphics in animation depending on the animation data included in the acquired display data when the vehicle is determined to be stopping in the determination while changing the three types of graphics in an order of an image including the before-switching graphic, an image including the suggestion graphic, and an image including the after-switching graphic, and displays each of the three types of graphics in a still image when the vehicle is determined to be traveling in the determination while changing the three types of graphics in an order of an image including the before-switching graphic, an image including the suggestion graphic, and an image including the after-switching graphic.

### Advantageous Effects of Invention

According to the present disclosure, it is possible to notify a user of a transition of a vehicle state accompanying switch of a gear position.

### BRIEF DESCRIPTION OF DRAWINGS

FIG. 1 is a configuration diagram illustrating a display control device 2 according to a first embodiment.

FIG. 2 is a hardware configuration diagram illustrating hardware of the display control device 2 according to the first embodiment.

FIG. 3 is a hardware configuration diagram of a computer in a case where the display control device 2 is implemented by software, firmware or the like.

FIG. 4 is a flowchart illustrating a display control method being a procedure performed by the display control device 2 according to the first embodiment.

FIG. 5A is an explanatory diagram of an image illustrating a vehicle state in a parking position P, FIG. 5B is an explanatory diagram of an image illustrating the vehicle state during switch from the parking position P to a reverse position R, FIG. 5C is an explanatory diagram of an image illustrating the vehicle state during switch from the parking position P to the reverse position R, and FIG. 5D is an explanatory diagram of an image illustrating the vehicle state in the reverse position R.

FIG. 6A is an explanatory diagram of an image illustrating the vehicle state in a neutral position N, FIG. 6B is an explanatory diagram of an image illustrating the vehicle state during switch from the neutral position N to a drive position D, FIG. 6C is an explanatory diagram of an image illustrating the vehicle state during switch from the neutral position N to the drive position D, and FIG. 6D is an explanatory diagram of an image illustrating the vehicle state in the drive position D.

FIG. 7A is an explanatory diagram of an image illustrating the vehicle state in the reverse position R, FIG. 7B is an explanatory diagram of an image illustrating the vehicle state during switch from the reverse position R to the neutral position N, FIG. 7C is an explanatory diagram of an image illustrating the vehicle state during switch from the reverse position R to the neutral position N, and FIG. 7D is an explanatory diagram of an image illustrating the vehicle state in the neutral position N.

FIG. 8 is a configuration diagram illustrating a display control device 2 according to a second embodiment.

FIG. 9 is a hardware configuration diagram illustrating hardware of the display control device 2 according to the second embodiment.

FIG. 10 is a flowchart illustrating a display control method being a procedure performed by the display control device 2 according to the second embodiment.

FIG. 11A is an explanatory diagram of an image illustrating a vehicle state in a drive position D when a vehicle is stopping, FIG. 11B is an explanatory diagram of an image illustrating the vehicle state during switch from the drive position D to a neutral position N when the vehicle is stopping, FIG. 11C is an explanatory diagram of an image illustrating the vehicle state during switch from the drive position D to the neutral position N when the vehicle is stopping, and FIG. 11D is an explanatory diagram of an image illustrating the vehicle state in the neutral position N when the vehicle is stopping.

FIG. 12A is an explanatory diagram of an image illustrating the vehicle state in the drive position D when the vehicle is traveling, FIG. 12B is an explanatory diagram of an image illustrating the vehicle state during switch from the drive position D to the neutral position N when the vehicle is traveling, FIG. 12C is an explanatory diagram of an image illustrating the vehicle state during switch from the drive position D to the neutral position N when the vehicle is traveling, and FIG. 12D is an explanatory diagram of an image illustrating the vehicle state in the neutral position N when the vehicle is traveling.

FIG. 13A is an explanatory diagram of an image illustrating the vehicle state in a parking position P, FIG. 13B is an explanatory diagram of an image illustrating the vehicle state during switch from the parking position P to a reverse position R, FIG. 13C is an explanatory diagram of an image illustrating the vehicle state during switch from the parking position P to the drive position D, and FIG. 13D is an explanatory diagram of an image illustrating the vehicle state in the drive position D.

### DESCRIPTION OF EMBODIMENTS

Some modes for carrying out the present disclosure are hereinafter described with reference to the attached drawings in order to describe the present disclosure in further detail.

### First Embodiment

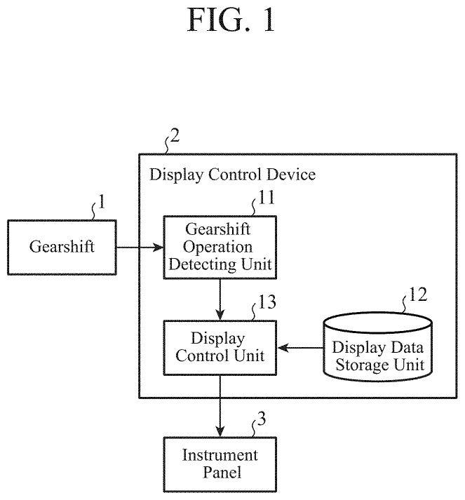

FIG. 1 is a configuration diagram illustrating a display control device 2 according to a first embodiment.

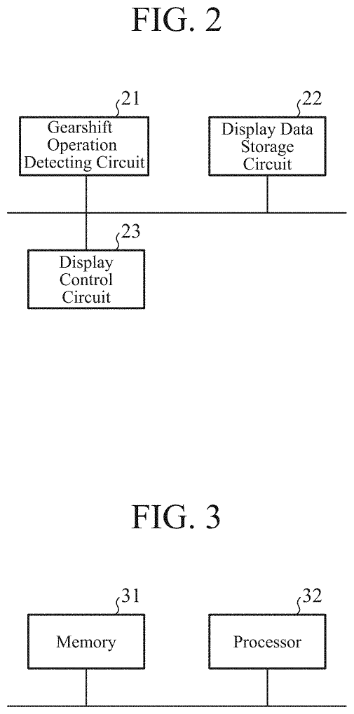

FIG. 2 is a hardware configuration diagram illustrating hardware of the display control device 2 according to the first embodiment.

A gearshift 1 accepts a gearshift operation of a vehicle and outputs gear selection information indicating a currently selected gear to the display control device 2.

The display control device 2 illustrated in FIG. 1 is provided with a gearshift operation detecting unit 11, a display data storage unit 12, and a display control unit 13.

The display control device 2 illustrated in FIG. 1 includes the display data storage unit 12. However, this is merely an example, and the display data storage unit 12 may also be provided outside the display control device 2.

The display control device 2 displays a speed meter, a tachometer, a fuel consumption meter, a fuel gauge, an eco-meter, a water thermometer, a distance meter, a vehicle state or the like on an instrument panel (hereinafter referred to as an “instrument panel”) 3.

The instrument panel 3 is a dashboard provided in front of the driver's seat of the vehicle, on which the speed meter, the tachometer, the fuel consumption meter, the fuel gauge, the eco-meter, the water thermometer, the distance meter, the vehicle state or the like are displayed.

The gearshift operation detecting unit 11 is implemented by a gearshift operation detecting circuit 21 illustrated in FIG. 2, for example.

The gearshift operation detecting unit 11 acquires the gear selection information from the gearshift 1.

The gearshift operation detecting unit 11 detects the gearshift operation of the vehicle by monitoring a change in gear selection information.

When detecting the gearshift operation of the vehicle, the gearshift operation detecting unit 11 specifies a switch content of a gear position of the vehicle accompanying the operation of the gearshift on the basis of the change in the gear selection information.

The gearshift operation detecting unit 11 outputs gear switch information indicating the switch content of the gear position of the vehicle to the display control unit 13.

The display data storage unit 12 is implemented by a display data storage circuit 22 illustrated in FIG. 2, for example.

The display data storage unit 12 stores, for each switch pattern of the gear position, display data of an image illustrating a transition of the vehicle state when the gear position of the vehicle is switched.

The display data stored in the display data storage unit 12 includes animation data for displaying a graphic indicating the transition of the vehicle state in animation.

The display control unit 13 is implemented by a display control circuit 23 illustrated in FIG. 2, for example.

The display control unit 13 acquires display data corresponding to the switch content indicated by the gear switch information output from the gearshift operation detecting unit 11 from the display data storage unit 12.

The display control unit 13 displays an image on the instrument panel 3 of the vehicle depending on the acquired display data.

When displaying the image on the instrument panel 3 of the vehicle depending on the display data, the display control unit 13 displays a graphic in animation depending on the animation data included in the display data.

In FIG. 1, it is assumed that each of the gearshift operation detecting unit 11, the display data storage unit 12, and the display control unit 13, which are components of the display control device 2, is implemented by dedicated hardware as illustrated in FIG. 2. That is, it is assumed that the display control device 2 is implemented by the gearshift operation detecting circuit 21, the display data storage circuit 22, and the display control circuit 23.

Herein, the display data storage circuit 22 corresponds to, for example, a non-volatile or volatile semiconductor memory such as a random access memory (RAM), a read only memory (ROM), a flash memory, an erasable programmable read only memory (EPROM), and an electrically erasable programmable read only memory (EEPROM), a magnetic disk, a flexible disk, an optical disk, a compact disk, a mini disk, a digital versatile disc (DVD) or the like.

Each of the gearshift operation detecting circuit 21 and the display control circuit 23 corresponds to, for example, a single circuit, a composite circuit, a programmed processor, a parallel-programmed processor, an application specific integrated circuit (ASIC), a field-programmable gate array (FPGA), or a combination thereof.

The components of the display control device 2 are not limited to those implemented by the dedicated hardware, and the display control device 2 may also be implemented by software, firmware, or a combination of software and firmware.

The software or firmware is stored as a program in a memory of a computer. The computer means hardware that executes the program, and corresponds to, for example, a central processing unit (CPU), a central processor, a processing unit, an arithmetic unit, a microprocessor, a microcomputer, a processor, a digital signal processor (DSP) or the like.

FIG. 3 is a hardware configuration diagram of the computer in a case where the display control device 2 is implemented by software, firmware or the like.

In a case where the display control device 2 is implemented by software, firmware or the like, the display data storage unit 12 is constructed on a memory 31 of the computer. Programs for causing the computer to execute the respective procedures performed by the gearshift operation detecting unit 11 and the display control unit 13 are stored in the memory 31. A processor 32 of the computer executes the programs stored in the memory 31.

FIG. 2 illustrates an example in which each of the components of the display control device 2 is implemented by dedicated hardware, and FIG. 3 illustrates an example in which the display control device 2 is implemented by software, firmware or the like. However, these are merely examples, and some components in the display control device 2 may be implemented by dedicated hardware, and the remaining components may be implemented by software, firmware or the like.

Next, an operation of the display control device 2 illustrated in FIG. 1 is described.

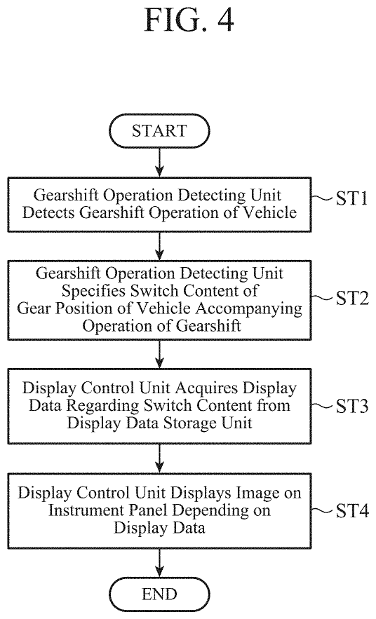

FIG. 4 is a flowchart illustrating a display control method being a procedure performed by the display control device 2 according to the first embodiment.

The gearshift 1 accepts the gearshift operation of the vehicle and outputs the gear selection information indicating the currently selected gear to the gearshift operation detecting unit 11 of the display control device 2.

The gearshift operation detecting unit 11 acquires the gear selection information from the gearshift 1.

The gearshift operation detecting unit 11 detects the gearshift operation of the vehicle by monitoring the change in gear selection information (step ST1 in FIG. 4).

When detecting the gearshift operation of the vehicle, the gearshift operation detecting unit 11 specifies the switch content of the gear position of the vehicle accompanying the operation of the gearshift on the basis of the change in gear selection information (step ST2 in FIG. 4).

The gearshift operation detecting unit 11 outputs gear switch information indicating the switch content of the gear position of the vehicle to the display control unit 13.

When the gearshift operation is a switch operation from a parking position P to a reverse position R, for example, the gearshift operation detecting unit 11 outputs the gear switch information indicating that the gear position is switched from the parking position P to the reverse position R to the display control unit 13.

When the gearshift operation is a switch operation from a neutral position N to a drive position D, for example, the gearshift operation detecting unit 11 outputs the gear switch information indicating that the gear position is switched from the neutral position N to the drive position D to the display control unit 13.

The display data storage unit 12 stores, for each switch pattern of the gear position, the display data of the image illustrating the transition of the vehicle state when the gear position of the vehicle is switched.

For example, display data of an image illustrating the transition of the vehicle state accompanying the switch from the parking position P to the reverse position R, display data of an image illustrating the transition of the vehicle state accompanying the switch from the neutral position N to the drive position D, display data of an image illustrating the transition of the vehicle state accompanying the switch from the reverse position R to the neutral position N and the like are stored in the display data storage unit 12.

These display data include, for example, animation data of the graphic indicating a vehicle state.

The image illustrating the transition of the vehicle state accompanying the switch from the parking position P to the reverse position R indicates that the vehicle state changes from a parking state to a state in which backward movement is possible.

The image illustrating the transition of the vehicle state accompanying the switch from the neutral position N to the drive position D indicates that the vehicle state changes from a state in which power of the engine is not transmitted to the axle to a state in which forward movement is possible.

The image illustrating the transition of the vehicle state accompanying the switch from the reverse position R to the neutral position N indicates that the vehicle state changes from the state in which the backward movement is possible to the state in which the power of the engine is not transmitted to the axle.

The display control unit 13 acquires the gear switch information from the gearshift operation detecting unit 11.

The display control unit 13 acquires the display data corresponding to the switch content indicated by the gear switch information from the display data storage unit 12 (step ST3 in FIG. 4).

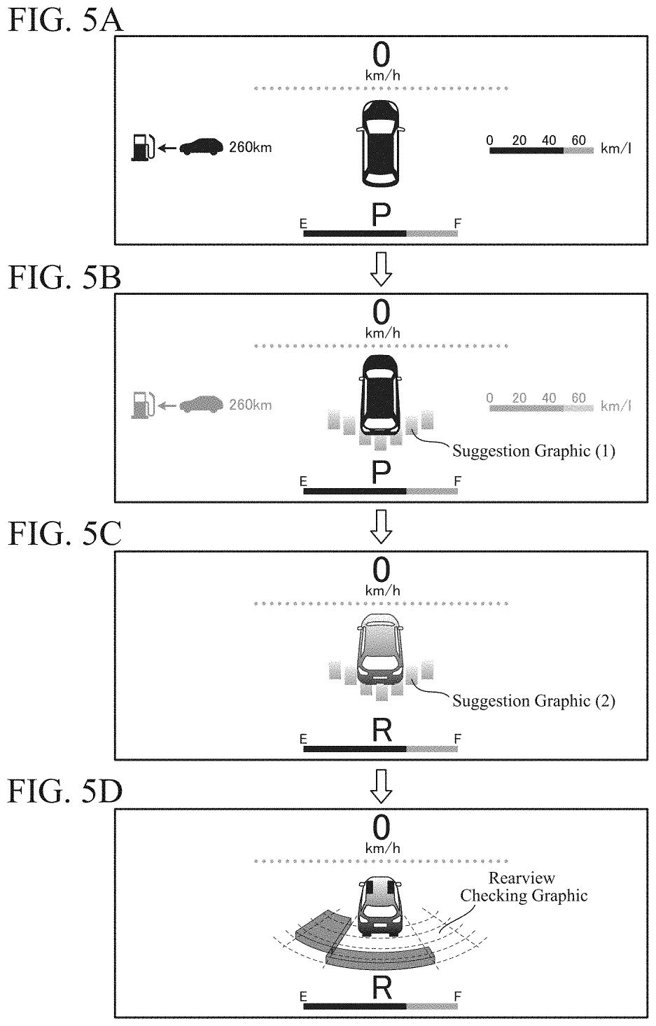

When the gear switch information indicates that the parking position P is switched to the reverse position R, the display control unit 13 acquires display data for displaying an image as illustrated in FIG. 5, for example.

FIG. 5 is an explanatory diagram of the image illustrating the transition of the vehicle state accompanying the switch from the parking position P to the reverse position R.

FIG. 5A is an explanatory diagram of an image illustrating the vehicle state in the parking position P.

In the image illustrated in FIG. 5A, a character “P” indicating that the gear position is the parking position P, “0 km/h” indicating a speed of the vehicle, “260 km” indicating a travelable distance of the vehicle, “50 km/l” indicating average fuel consumption of the vehicle, and a fuel gauge are displayed. Needless to say, each of “0 km/h”, “260 km”, and “50 km/l” is an example.

FIG. 5B is an explanatory diagram of an image illustrating the vehicle state during the switch from the parking position P to the reverse position R.

In the image illustrated in FIG. 5B, as in the image illustrated in FIG. 5A, the character “P” indicating that the gear position is the parking position P, “0 km/h” indicating the speed of the vehicle, “260 km” indicating the travelable distance of the vehicle, “50 km/l” indicating the average fuel consumption of the vehicle, and the fuel gauge are displayed.

However, in the image illustrated in FIG. 5B, “260 km” indicating the travelable distance and “50 km/l” indicating the average fuel consumption of the vehicle are displayed in lighter color than those in the image illustrated in FIG. 5A.

In the image illustrated in FIG. 5B, unlike the image illustrated in FIG. 5A, rod-shaped figures are displayed around the vehicle graphic as a suggestion graphic (1) suggesting that the gear position is switched to the reverse position R.

FIG. 5C is an explanatory diagram of an image illustrating the vehicle state during the switch from the parking position P to the reverse position R.

In the image illustrated in FIG. 5C, a character “R” indicating that the gear position is the reverse position R, “0 km/h” indicating the speed of the vehicle, and the fuel gauge are displayed.

In the image illustrated in FIG. 5C, rod-shaped figures are displayed on the rear side of the vehicle as a suggestion graphic (2) suggesting that the gear position is switched to the reverse position R.

FIG. 5D is an explanatory diagram of an image illustrating the vehicle state in the reverse position R.

In the image illustrated in FIG. 5D, the character “R” indicating that the gear position is the reverse position R, “0 km/h” indicating the speed of the vehicle, and the fuel gauge are displayed.

In the image illustrated in FIG. 5D, a rear checking graphic indicating each of a distance to an object and the like present on the rear side of the vehicle and a tire angle of the vehicle is displayed on the rear side of the vehicle.

Each of the suggestion graphic (1), the suggestion graphic (2), and the rear checking graphic is a graphic indicating a vehicle state and is displayed in animation.

As the animation display in each of the suggestion graphic (1) and the suggestion graphic (2), a change in the length of each of the rod-shaped figures, blinking of the rod-shaped figures, a change in display position of the rod-shaped figures or the like is conceivable.

As the animation display of the rear checking graphic, a change in display position accompanying a change in distance to an object and the like present on the rear side of the vehicle, a change in display position accompanying the change in tire angle of the vehicle or the like is conceivable.

In the image illustrated in FIG. 5, there are two images as the images during the switch from the parking position P to the reverse position R. However, this is merely an example, and the images during the switch may be one image or three or more images.

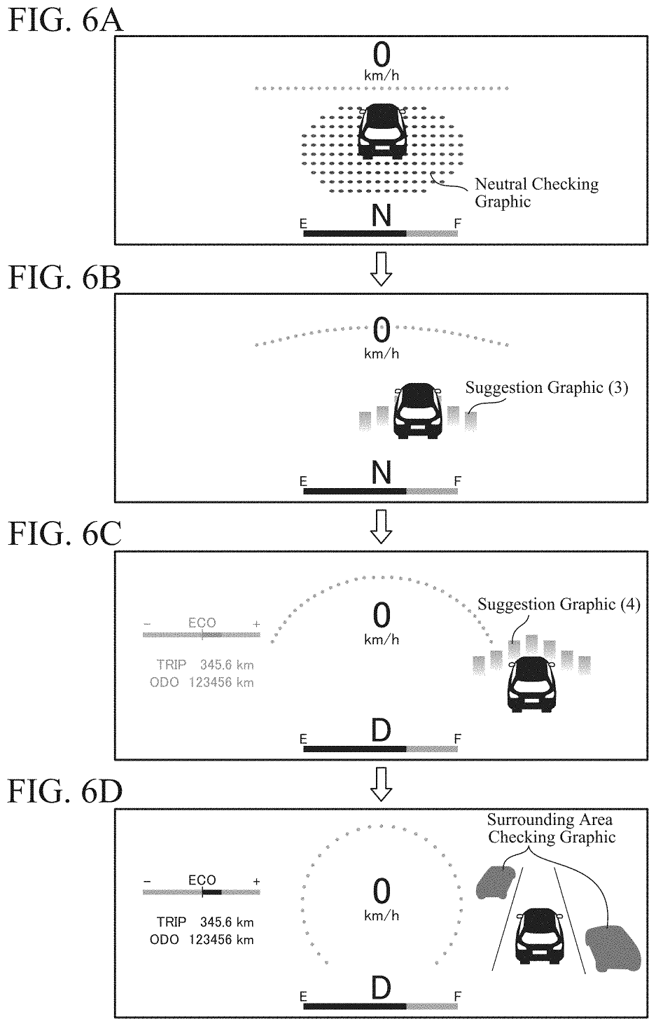

When the gear switch information indicates that the neutral position N is switched to the drive position D, the display control unit 13 acquires display data for displaying an image as illustrated in FIG. 6, for example.

FIG. 6 is an explanatory diagram of the image illustrating the transition of the vehicle state accompanying the switch from the neutral position N to the drive position

D.

FIG. 6A is an explanatory diagram of an image illustrating the vehicle state in the neutral position N.

In the image illustrated in FIG. 6A, a character “N” indicating that the gear position is the neutral position N, “0 km/h” indicating the speed of the vehicle, and the fuel gauge are displayed.

In the image illustrated in FIG. 6A, a figure of a plurality of dots is displayed around the vehicle graphic as a neutral checking graphic indicating that the vehicle state is the state in which the power of the engine is not transmitted to the axle.

FIG. 6B is an explanatory diagram of an image illustrating the vehicle state during the switch from the neutral position N to the drive position D.

In the image illustrated in FIG. 6B, as in the image illustrated in FIG. 6A, the character “N” indicating that the gear position is the neutral position N, “0 km/h” indicating the speed of the vehicle, and the fuel gauge are displayed.

In the image illustrated in FIG. 6B, unlike the image illustrated in FIG. 6A, a figure of a plurality of dots is displayed around the vehicle graphic as a suggestion graphic (3) suggesting that the gear position is switched to the drive position D. The suggestion graphic (3) is displayed in lighter color than the neutral checking graphic illustrated in FIG. 6A.

FIG. 6C is an explanatory diagram of an image illustrating the vehicle state during the switch from the neutral position N to the drive position D.

In the image illustrated in FIG. 6C, an eco-meter indicating a degree of achievement of energy saving, a character “D” indicating that the gear position is the drive position D, “0 km/h” indicating the speed of the vehicle, “123456 km” indicating a total travel distance of the vehicle (hereinafter referred to as “ODO”), “345.6 km” indicating a sectional travel distance of the vehicle (hereinafter referred to as “TRIP”), and the fuel gauge are displayed.

In the image illustrated in FIG. 6C, rod-shaped figures are displayed on the lateral side and the front side of the vehicle as a suggestion graphic (4) suggesting that the gear position is switched to the drive position D.

FIG. 6D is an explanatory diagram of an image illustrating the vehicle state in the drive position D.

In the image illustrated in FIG. 6D, as in the image illustrated in FIG. 6C, the eco-meter, the character “D” indicating that the gear position is the drive position D, “0 km/h” indicating the speed of the vehicle, “123456 km” indicating ODO, “345.6 km” indicating the TRIP, and the fuel gauge are displayed.

In the image illustrated in FIG. 6D, unlike the image illustrated in FIG. 6C, a surrounding area checking graphic indicating an object and the like present around the vehicle is displayed around the vehicle graphic.

Each of the neutral checking graphic, the suggestion graphic (3), the suggestion graphic (4), and the surrounding area checking graphic is a graphic indicating a vehicle state and is displayed in animation.

As the animation display of the neutral checking graphic, a change in display position of the dot-shaped figures, blinking of the dot-shaped figures or the like is conceivable.

As the animation display in each of the suggestion graphic (3) and the suggestion graphic (4), a change in the length of each of the rod-shaped figures, blinking of the rod-shaped figures, a change in display position of the rod-shaped figures or the like is conceivable.

As the animation display of the surrounding area checking graphic, a change in display position accompanying a change in position of the object present around the vehicle or the like is conceivable.

In the image illustrated in FIG. 6, there are two images as the image during the switch from the neutral position N to the drive position D. However, this is merely an example, and the images during the switch may be one image or three or more images.

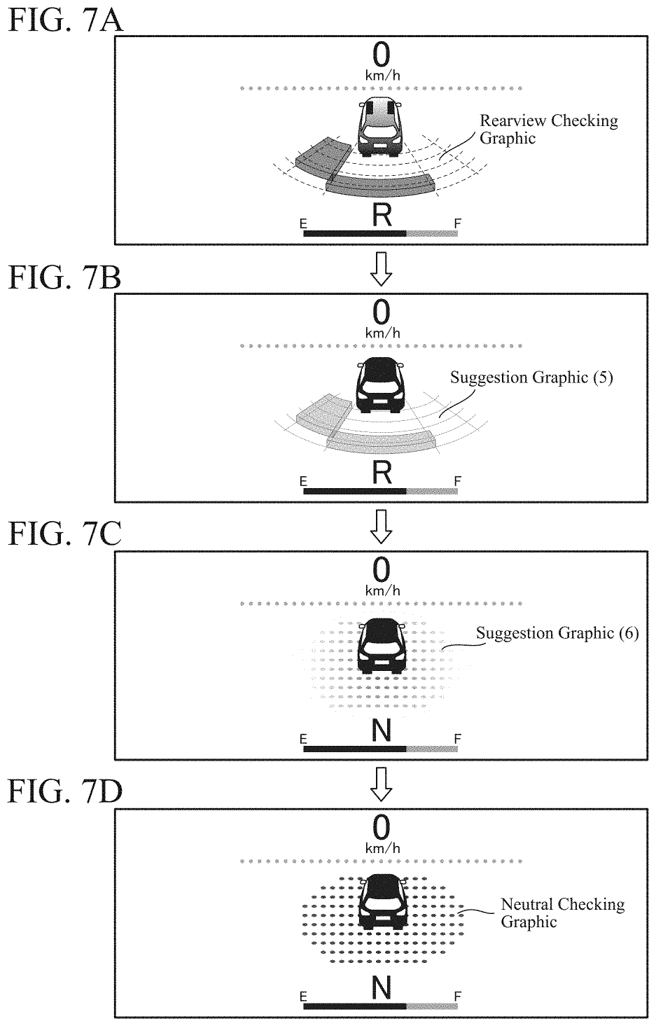

When the gear switch information indicates that the reverse position R is switched to the neutral position N, the display control unit 13 acquires display data for displaying an image as illustrated in FIG. 7, for example.

FIG. 7 is an explanatory diagram of an image illustrating transition of the vehicle state accompanying the switch from the reverse position R to the neutral position N.

FIG. 7A is an explanatory diagram of an image illustrating the vehicle state in the reverse position R.

In the image illustrated in FIG. 7A, the character “R” indicating that the gear position is the reverse position R, “0 km/h” indicating the speed of the vehicle, and the fuel gauge are displayed.

In the image illustrated in FIG. 7A, a rear checking graphic is displayed on the rear side of the vehicle.

FIG. 7B is an explanatory diagram of an image illustrating the vehicle state during the switch from the reverse position R to the neutral position N.

In the image illustrated in FIG. 7B, the character “R” indicating that the gear position is the reverse position R, “0 km/h” indicating the speed of the vehicle, and the fuel gauge are displayed.

In the image illustrated in FIG. 7B, a suggestion graphic (5) suggesting the switch to the neutral position N is displayed on the rear side of the vehicle.

FIG. 7C is an explanatory diagram of an image illustrating the vehicle state during the switch from the reverse position R to the neutral position N.

In the image illustrated in FIG. 7C, the character “N” indicating that the gear position is the neutral position N, “0 km/h” indicating the speed of the vehicle, and the fuel gauge are displayed.

In the image illustrated in FIG. 7C, a figure of a plurality of dots is displayed around the vehicle graphic as a suggestion graphic (6) suggesting that the gear position is switched to the neutral position N.

FIG. 7D is an explanatory diagram of an image illustrating the vehicle state in the neutral position N.

In the image illustrated in FIG. 7D, the character “N” indicating that the gear position is the neutral position N, “0 km/h” indicating the speed of the vehicle, and the fuel gauge are displayed.

In the image illustrated in FIG. 7D, a figure of a plurality of dots is displayed around the vehicle graphic as the neutral confirming graphic. The neutral checking graphic is displayed in darker color than the suggestion graphic (6) illustrated in FIG. 7C.

Each of the rear checking graphic, the suggestion graphic (5), the suggestion graphic (6), and the neutral checking graphic is a graphic indicating a vehicle state and is displayed in animation.

As the animation display in each of the suggestion graphic (5) and the suggestion graphic (6), a change in length of rod-shaped figures, blinking of the rod-shaped figures, a change in display position of the rod-shaped figures or the like is conceivable.

In the image illustrated in FIG. 7, there are two images as the images during the switch from the reverse position R to the neutral position N. However, this is merely an example, and the images during the switch may be one image or three or more images.

The display control unit 13 displays the image on the instrument panel 3 of the vehicle depending on the acquired display data (step ST4 in FIG. 4).

For example, in a case of switching from the parking position P to the reverse position R, the display control unit 13 displays the image as illustrated in FIG. 5 on the instrument panel 3.

For example, in a case of switching from the neutral position N to the drive position D, the display control unit 13 displays the image as illustrated in FIG. 6 on the instrument panel 3.

For example, in a case of switching from the reverse position R to the neutral position N, the display control unit 13 displays the image as illustrated in FIG. 7 on the instrument panel 3.

The images as illustrated in FIGS. 5 to 7 are displayed on the instrument panel 3, so that the transition of the vehicle state accompanying the switch of the gear position can be grasped. Therefore, for example, in a case where the gearshift operation of the vehicle by a user is different from a desired software operation, there is a possibility that the user can notice an error in gearshift operation before the display of the image illustrating the vehicle state in the switched gear position is completed.

In the first embodiment described above, the display control device 2 is configured to include the gearshift operation detecting unit 11 that detects the operation of the gearshift 1 of the vehicle and outputs the gear switch information indicating the switch content of the gear position of the vehicle accompanying the operation of the gearshift 1, and the display control unit 13 that acquires the display data corresponding to the switch content indicated by the gear switch information output from the gearshift operation detecting unit 11 from the display data storage unit 12 that stores the display data of the image illustrating the transition of the vehicle state when the gear position of the vehicle is switched for each of switch patterns of the gear position, and displays the image on the instrument panel 3 of the vehicle depending on the acquired display data. Therefore, the display control device 2 can notify the user of the transition of the vehicle state accompanying the switch of the gear position.

### Second Embodiment

In a second embodiment, a display control device 2 is described in which a display control unit 15 displays a graphic in animation depending on animation data included in acquired display data when a vehicle is stopping, and displays a graphic in a still image when the vehicle is traveling.

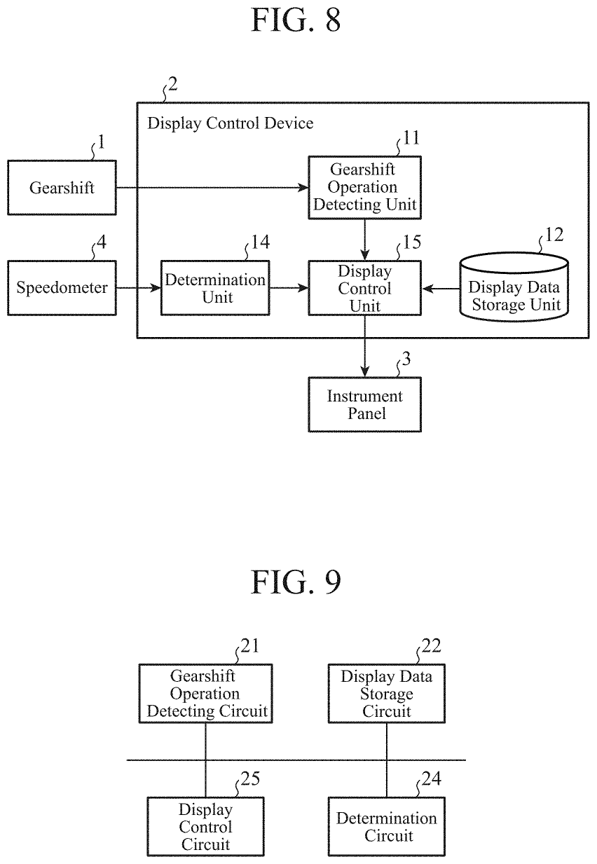

FIG. 8 is a configuration diagram illustrating the display control device 2 according to the second embodiment. In FIG. 8, the same reference sign as that in FIG. 1 represents the same or corresponding portion, so that the description thereof is omitted.

FIG. 9 is a hardware configuration diagram illustrating hardware of the display control device 2 according to the second embodiment. In FIG. 9, the same reference sign as that in FIG. 2 represents the same or corresponding portion, so that the description thereof is omitted.

A speedometer 4 measures a speed of a vehicle and outputs vehicle speed information indicating the speed of the vehicle to the display control device 2.

The display control device 2 illustrated in FIG. 8 is provided with a gearshift operation detecting unit 11, a display data storage unit 12, a determination unit 14, and a display control unit 15.

The determination unit 14 is implemented by a determination circuit 24 illustrated in FIG. 9, for example.

The determination unit 14 acquires the vehicle speed information from the speedometer 4.

The determination unit 14 monitors the speed of the vehicle indicated by the vehicle speed information, and determines whether the vehicle is traveling or the vehicle is stopping.

The determination unit 14 outputs a determination result indicating whether the vehicle is traveling or the vehicle is stopping to the display control unit 15.

The display control unit 15 is implemented by a display control circuit 25 illustrated in FIG. 9, for example.

The display control unit 15 acquires display data corresponding to a switch content indicated by gear switch information output from the gearshift operation detecting unit 11 from the display data storage unit 12 as is the case with the display control unit 13 illustrated in FIG. 1.

When the determination unit 14 determines that the vehicle is stopping, the display control unit 15 displays an image on an instrument panel 3 of the vehicle depending on the acquired display data as is the case with the display control unit 13 illustrated in FIG. 1. The display control unit 15 displays a graphic in animation depending on the animation data included in the acquired display data.

When the determination unit 14 determines that the vehicle is traveling, the display control unit 15 displays the image on the instrument panel 3 of the vehicle depending on the acquired display data in a state in which the graphic is a still image.

In FIG. 8, it is assumed that each of the gearshift operation detecting unit 11, the display data storage unit 12, the determination unit 14, and the display control unit 15, which are components of the display control device 2, is implemented by dedicated hardware as illustrated in FIG. 9. That is, it is assumed that the display control device 2 is implemented by the gearshift operation detecting circuit 21, the display data storage circuit 22, the determination circuit 24, and the display control circuit 25.

Each of the gearshift operation detecting circuit 21, the determination circuit 24, the display control circuit 25 corresponds to, for example, a single circuit, a composite circuit, a programmed processor, a parallel-programmed processor, an ASIC, a FPGA, or a combination thereof.

The components of the display control device 2 are not limited to those implemented by dedicated hardware, and the display control device 2 may also be implemented by software, firmware, or a combination of the software and firmware.

In a case where the display control device 2 is implemented by software, firmware or the like, the display data storage unit 12 is constructed on the memory 31 of a computer illustrated in FIG. 3. A program for causing the computer to execute each procedure performed by the gearshift operation detecting unit 11, the determination unit 14, and the display control unit 15 is stored in the memory 31. The processor 32 illustrated in FIG. 3 executes the program stored in the memory 31.

FIG. 9 illustrates an example in which each of the components of the display control device 2 is implemented by dedicated hardware, and FIG. 3 illustrates an example in which the display control device 2 is implemented by software, firmware or the like. However, these are merely examples, and some components in the display control device 2 may be implemented by dedicated hardware, and the remaining components may be implemented by software, firmware or the like.

Next, an operation of the display control device 2 illustrated in FIG. 8 is described.

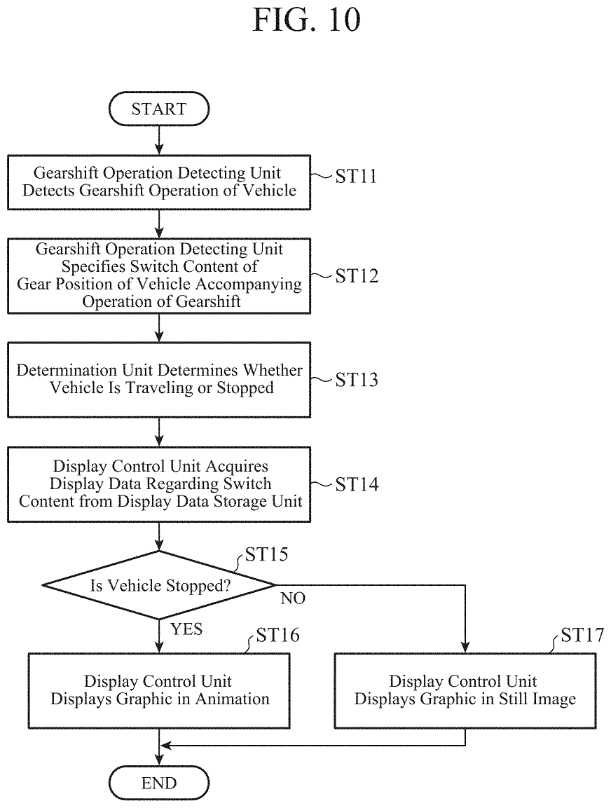

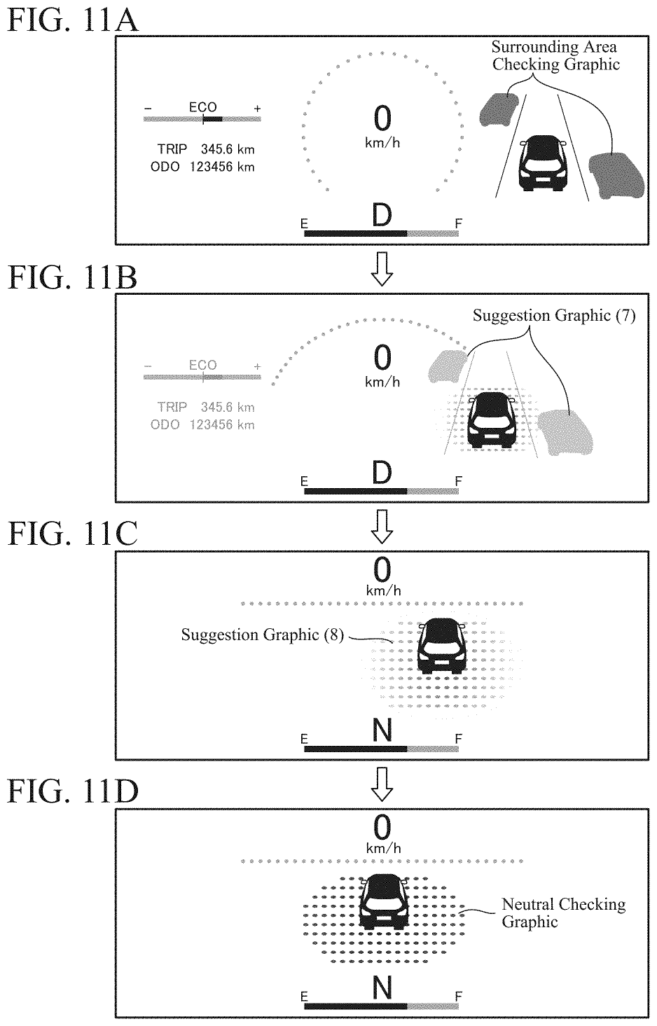

FIG. 10 is a flowchart illustrating a display control method being a procedure performed by the display control device 2 according to the second embodiment.

The gearshift 1 accepts the gearshift operation of the vehicle and outputs the gear selection information indicating the currently selected gear to the gearshift operation detecting unit 11 of the display control device 2.

The speedometer 4 measures a speed V of the vehicle and outputs the vehicle speed information indicating the speed V of the vehicle to the determination unit 14 of the display control device 2.

The gearshift operation detecting unit 11 acquires the gear selection information from the gearshift 1.

The gearshift operation detecting unit 11 detects the gearshift operation of the vehicle by monitoring a change in gear selection information as is the case with the described content in the first embodiment (step ST11 in FIG. 10).

When detecting the gearshift operation of the vehicle, the gearshift operation detecting unit 11 specifies a switch content of a gear position of the vehicle accompanying the operation of the gearshift on the basis of the change in gear selection information (step ST12 in FIG. 10).

The gearshift operation detecting unit 11 outputs gear switch information indicating the switch content of the gear position of the vehicle to the display control unit 15.

The determination unit 14 acquires the vehicle speed information from the speedometer 4.

The determination unit 14 monitors the speed V of the vehicle indicated by the vehicle speed information, and determines whether the vehicle is traveling or the vehicle is stopping (step ST13 in FIG. 10).

That is, the determination unit 14 determines that the vehicle is traveling when the speed V of the vehicle is not 0 [km/h], and determines that the vehicle is stopping when the speed V of the vehicle is 0 [km/h].

The determination unit 14 outputs a determination result indicating whether the vehicle is traveling or the vehicle is stopping to the display control unit 15.

The display control unit 15 acquires the display data corresponding to the switch content indicated by the gear switch information output from the gearshift operation detecting unit 11 from the display data storage unit 12 as is the case with the display control unit 13 illustrated in FIG. 1 (step ST14 in FIG. 10).

The display control unit 15 acquires the determination result indicating whether the vehicle is traveling or the vehicle is stopping from the determination unit 14.

The display control unit 15 displays the image on the instrument panel 3 of the vehicle depending on the acquired display data.

When the determination result of the determination unit 14 indicates that the vehicle is stopping (YES at step ST15 in FIG. 10), when displaying the image on the instrument panel 3 of the vehicle depending on the acquired display data, the display control unit 15 displays the graphic in animation depending on the animation data included in the acquired display data as is the case with the display control unit 13 illustrated in FIG. 1 (step ST16 in FIG. 10).

When the determination result of the determination unit 14 indicates that the vehicle is traveling (NO at step ST15 in FIG. 10), the display control unit 15 displays the image on the instrument panel 3 of the vehicle depending on the acquired display data in a state in which the graphic is a still image (step ST17 in FIG. 10).

As a mode in which the gearshift operation is performed when the vehicle is traveling and when the vehicle is stopping, for example, the gearshift operation in which the gear position is switched from a drive position D to a neutral position N is conceivable.

FIG. 11 is an explanatory diagram of an image illustrating a transition of a vehicle state accompanying the switch from the drive position D to the neutral position N when the vehicle is stopping.

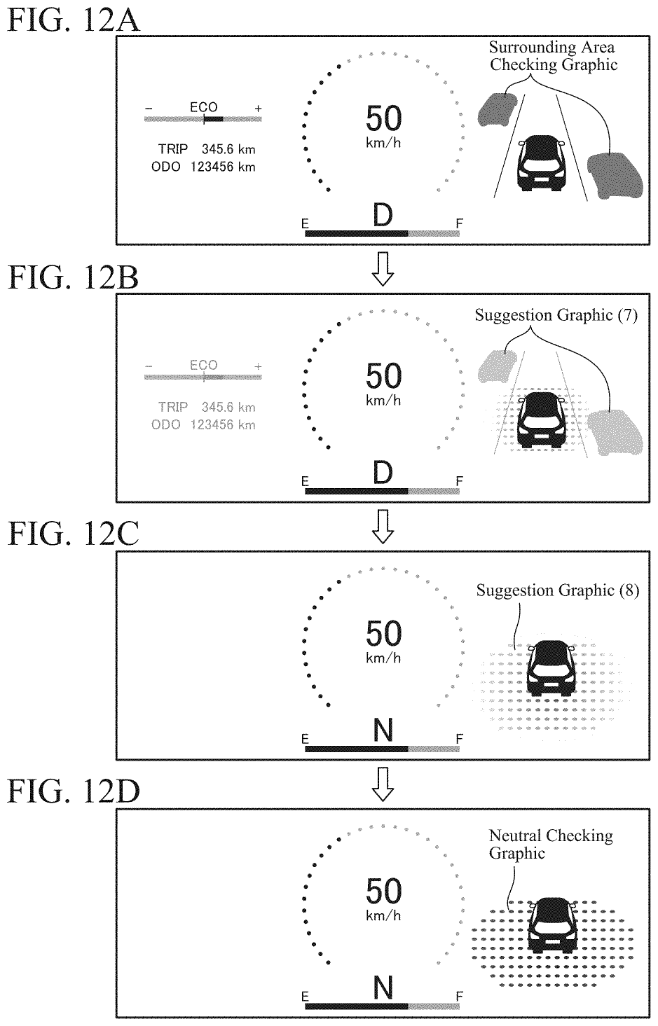

FIG. 12 is an explanatory diagram of an image illustrating the transition of the vehicle state accompanying the switch from the drive position D to the neutral position N when the vehicle is traveling.

FIG. 11A is an explanatory diagram of an image illustrating the vehicle state in the drive position D when the vehicle is stopping.

In the image illustrated in FIG. 11A, an eco-meter, a character “D” indicating that the gear position is the drive position D, “0 km/h” indicating the speed of the vehicle, “123456 km” indicating ODO, “345.6 km” indicating the TRIP, a fuel gauge, and a surrounding area checking graphic are displayed.

FIG. 11B is an explanatory diagram of an image illustrating the vehicle state during the switch from the drive position D to the neutral position N when the vehicle is stopping.

In the image illustrated in FIG. 11B, the eco-meter, the character “D” indicating that the gear position is the drive position D, “0 km/h” indicating the speed of the vehicle, “123456 km” indicating ODO, “345.6 km” indicating the TRIP, the fuel gauge, and a suggestion graphic (7) suggesting that the gear position is switched to the neutral position N are displayed. The eco-meter, “123456 km” indicating ODO, “345.6 km” indicating the TRIP, and the suggestion graphic (7) are displayed in lighter color than the eco-meter, “123456 km” indicating ODO, “345.6 km” indicating the TRIP, and the surrounding area checking graphic illustrated in FIG. 11A, respectively.

FIG. 11C is an explanatory diagram of an image illustrating the vehicle state during the switch from the drive position D to the neutral position N when the vehicle is stopping.

In the image illustrated in FIG. 11C, a character “N” indicating that the gear position is the neutral position N, “0 km/h” indicating the speed of the vehicle, the fuel gauge, and a suggestion graphic (8) suggesting that the gear position is switched to the neutral position N are displayed.

FIG. 11D is an explanatory diagram of an image illustrating the vehicle state in the neutral position N when the vehicle is stopping.

In the image illustrated in FIG. 11D, the character “N” indicating that the gear position is the neutral position N, “0 km/h” indicating the speed of the vehicle, the fuel gauge, and a neutral checking graphic are displayed. The neutral checking graphic is displayed in darker color than the suggestion graphic (8) illustrated in FIG. 11C.

Each of the surrounding area checking graphic, the suggestion graphic (7), the suggestion graphic (8), and the neutral checking graphic is a graphic indicating a vehicle state and is displayed in animation.

FIG. 12A is an explanatory diagram of an image illustrating the vehicle state in the drive position D when the vehicle is traveling.

In the image illustrated in FIG. 12A, the eco-meter, a character “D” indicating that the gear position is the drive position D, “50 km/h” indicating the speed of the vehicle, “123456 km” indicating ODO, “345.6 km” indicating the TRIP, the fuel gauge, and the surrounding area checking graphic are displayed.

FIG. 12B is an explanatory diagram of an image illustrating the vehicle state during the switch from the drive position D to the neutral position N when the vehicle is traveling.

In the image illustrated in FIG. 12B, the eco-meter, the character “D” indicating that the gear position is the drive position D, “50 km/h” indicating the speed of the vehicle, “123456 km” indicating ODO, “345.6 km” indicating the TRIP, the fuel gauge, and the suggestion graphic (7) suggesting that the gear position is switched to the neutral position N are displayed. The eco-meter, “123456 km” indicating ODO, “345.6 km” indicating the TRIP, and the suggestion graphic (7) are displayed in lighter color than the eco-meter, “123456 km” indicating ODO, “345.6 km” indicating the TRIP, and the surrounding area checking graphic illustrated in FIG. 12A, respectively.

FIG. 12C is an explanatory diagram of an image illustrating the vehicle state during the switch from the drive position D to the neutral position N when the vehicle is traveling.

In the image illustrated in FIG. 12C, the character “N” indicating that the gear position is the neutral position N, “50 km/h” indicating the speed of the vehicle, the fuel gauge, and the suggestion graphic (8) suggesting that the gear position is switched to the neutral position N are displayed.

FIG. 12D is an explanatory diagram of an image illustrating the vehicle state in the neutral position N when the vehicle is traveling.

In the image illustrated in FIG. 12D, the character “N” indicating that the gear position is the neutral position N, “50 km/h” indicating the speed of the vehicle, the fuel gauge, and the neutral checking graphic are displayed. The neutral checking graphic is displayed in darker color than the suggestion graphic (8) illustrated in FIG. 12C.

Each of the surrounding area checking graphic, the suggestion graphic (7), the suggestion graphic (8), and the neutral checking graphic is a graphic indicating a vehicle state. Note that, each of the surrounding area checking graphic, the suggestion graphic (7), the suggestion graphic (8), and the neutral checking graphic is displayed in a still image.

In the second embodiment described above, the display control device 2 is configured to be provided with the determination unit 14 that monitors the speed of the vehicle and determines whether the vehicle is traveling or the vehicle is stopping. The display control unit 15 of the display control device 2 displays the graphic in animation depending on the animation data included in the acquired display data when the determination unit 14 determines that the vehicle is stopping, and displays the graphic in a still image when the determination unit 14 determines that the vehicle is traveling. Therefore, as is the case with the display control device 2 illustrated in FIG. 1, the display control device 2 illustrated in FIG. 8 can notify a user of the transition of the vehicle state accompanying the switch of the gear position, and can stop the animation display that might distract the attention of a driver during the travel.

### Third Embodiment

In a third embodiment, when a gearshift operation detecting unit 11 further detects a gearshift operation while an image is being displayed by a display control unit 13, so that gear shift information is further output from the gearshift operation detecting unit 11, the display control unit 13 further acquires display data corresponding to a switch content indicated by gear switch information further output from the gearshift operation detecting unit 11 from a display data storage unit 12. The display control device 2 in which the display control unit 13 displays an image on an instrument panel 3 depending on the further acquired display data is described.

A configuration of the display control device 2 according to the third embodiment is similar to the configuration of the display control device 2 according to the first embodiment, and FIG. 1 is a configuration diagram illustrating the display control device 2 according to the third embodiment.

Next, an operation of the display control device 2 according to the third embodiment is described.

The gearshift operation of the vehicle is performed, so that a gear position is switched.

The first embodiment describes that an image illustrating a transition of a vehicle state when the gear position is switched from a parking position P to a reverse position R, for example, is displayed on the instrument panel 3 by the display control unit 13.

While the image is being displayed by the display control unit 13, the gearshift operation may be further detected by the gearshift operation detecting unit 11. For example, there is a case where the parking position P is switched to a drive position D via the reverse position R and a neutral position N.

The gearshift operation detecting unit 11 acquires gear selection information from a gearshift 1 also while the image is being displayed by the display control unit 13.

The gearshift operation detecting unit 11 detects the gearshift operation of the vehicle by monitoring a change in gear selection information.

When detecting the gearshift operation of the vehicle, the gearshift operation detecting unit 11 specifies a switch content of a gear position of the vehicle accompanying the operation of the gearshift on the basis of the change in gear selection information.

The gearshift operation detecting unit 11 outputs gear switch information indicating the switch content of the gear position of the vehicle to the display control unit 13.

When the gearshift operation is further detected by the gearshift operation detecting unit 11 before the display of the image illustrating the transition of the vehicle state is completed, so that the gear switch information is further output from the gearshift operation detecting unit 11, the display control unit 13 acquires the gear switch information.

The display control unit 13 further acquires display data corresponding to the switch content of the gear position of the vehicle accompanying the operation of the gearshift from the display data storage unit 12 on the basis of the change in the acquired gear switch information.

The display control unit 13 displays an image on the instrument panel 3 depending on the further acquired display data before the display of the image currently being displayed is completed.

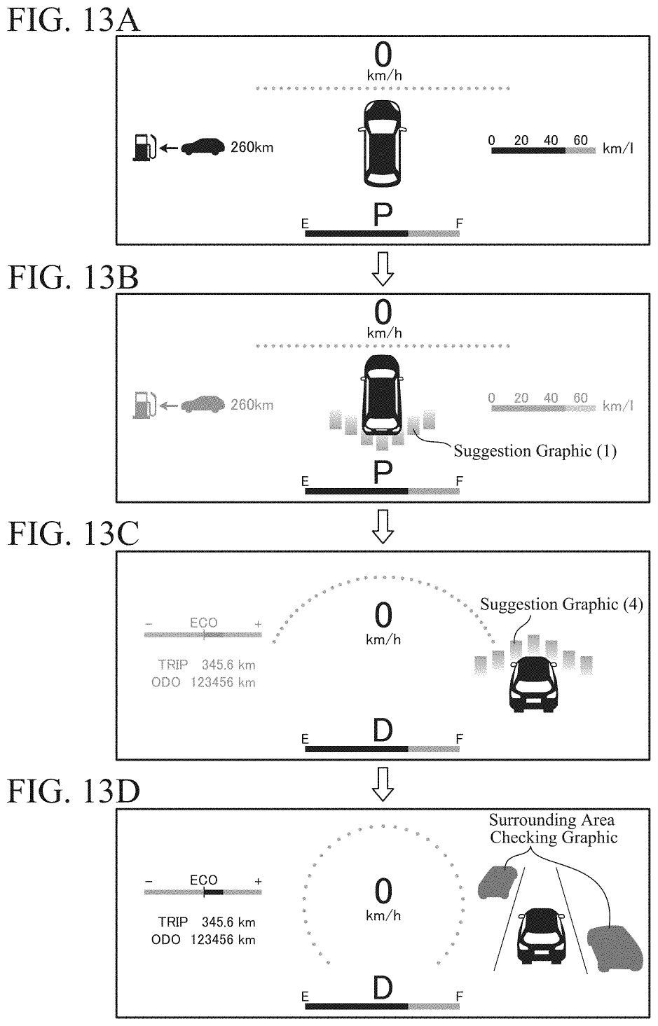

FIG. 13 is an explanatory diagram of an image illustrating a transition of the vehicle state when the gear position is switched to the drive position D before the display of the image illustrating the transition of the vehicle state accompanying the switch from the parking position P to the reverse position R is completed.

In FIG. 13, an image illustrating the vehicle state in the reverse position R is not displayed but an image illustrating the vehicle state in the drive position D is displayed.

FIG. 13A is an explanatory diagram of an image illustrating the vehicle state in the parking position P.

In the image illustrated in FIG. 13A, a character “P” indicating that the gear position is the parking position P, “0 km/h” indicating a speed of the vehicle, “260 km” indicating a travelable distance of the vehicle, a fuel consumption meter, and a fuel gauge are displayed.

FIG. 13B is an explanatory diagram of an image illustrating the vehicle state during the switch from the parking position P to the reverse position R.

In the image illustrated in FIG. 13B, the character “P” indicating that the gear position is the parking position P, “0 km/h” indicating the speed of the vehicle, “260 km” indicating the travelable distance of the vehicle, the fuel consumption meter, and the fuel gauge are displayed.

However, in the image illustrated in FIG. 13B, “260 km” indicating the travelable distance and the fuel consumption meter indicating fuel consumption of the vehicle are displayed in lighter color than those in the image illustrated in FIG. 13A.

In the image illustrated in FIG. 13B, unlike the image illustrated in FIG. 13A, a suggestion graphic (1) suggesting that the gear position is switched to the reverse position R is displayed.

FIG. 13C is an explanatory diagram of an image illustrating the vehicle state during the switch from the parking position P to the drive position D.

In the image illustrated in FIG. 13C, the eco-meter, a character “D” indicating that the gear position is the drive position D, “0 km/h” indicating the speed of the vehicle, “123456 km” indicating ODO, “345.6 km” indicating the TRIP, the fuel gauge, and the suggestion graphic (4) suggesting that the gear position is switched to the drive position D are displayed.

FIG. 13D is an explanatory diagram of an image illustrating the vehicle state in the drive position D.

In the image illustrated in FIG. 13D, the eco-meter, the character “D” indicating that the gear position is the drive position D, “0 km/h” indicating the speed of the vehicle, “123456 km” indicating ODO, “345.6 km” indicating the TRIP, and the fuel gauge are displayed.

In the image illustrated in FIG. 13D, unlike the image illustrated in FIG. 13C, a surrounding area checking graphic is displayed around the vehicle graphic.

Each of a neutral checking graphic, the suggestion graphic (1), the suggestion graphic (4), and the surrounding area checking graphic is a graphic indicating a vehicle state and is displayed in animation.

In the image illustrated in FIG. 13, there are two images as the images during the switch from the parking position P to the drive position D. However, this is merely an example, and the images during the switch may be one image or three or more images.

Here, the display control unit 13 displays the image on the instrument panel 3 depending on the further acquired display data before the display of the image currently being displayed is completed. However, this is merely an example, and the display control unit 13 may display the image on the instrument panel 3 depending on the further acquired display data after the display of the image currently being displayed is completed.

For example, in a case where the gear position is switched to the drive position D before the display of the image illustrating the transition of the vehicle state accompanying the switch from the parking position P to the reverse position R is completed, the display control unit 13 completes the display of the image as illustrated in FIG. 5.

At that time, the display control unit 13 increases each of the transmittance of the image currently being displayed and a switch speed of the image currently being displayed, and completes the display of the image. For example, the transmittance of each of the suggestion graphics (1) and (2) and a rear checking graphic is increased. The switch speed of the images from FIG. 5A to FIG. 5D is increased.

After the display of the image as illustrated in FIG. 5 is completed, the display control unit 13 displays the images as illustrated in FIGS. 13C and 13D, the images as illustrated in FIGS. 6B, 6C, and 6D or the like on the instrument panel 3.

At that time, the display control unit 13 decreases the transmittance of each of the suggestion graphic (4) and the surrounding area checking graphic as compared to the transmittance of each of the suggestion graphic (1) and (2) and the rear checking graphic.

Note that, in the present disclosure, the embodiments can be freely combined, any component of each embodiment can be modified, or any component can be omitted in each embodiment.

### INDUSTRIAL APPLICABILITY

The present disclosure is suitable for the display control device and the display control method.

### REFERENCE SIGNS LIST

1: gearshift, 2: display control device, 3: instrument panel, 4: speedometer, 11: gearshift operation detecting unit, 12: display data storage unit, 13: display control unit, 14: determination unit, 15: display control unit, 21: gearshift operation detecting circuit, 22: display data storage circuit, 23: display control circuit, 24: determination circuit, 25: display control circuit, 31: memory, 32: processor

1. A display control device comprising processing circuitry
to perform detection of an operation of a gearshift of a vehicle and output gear switch information indicating a switch content of a gear position of the vehicle accompanying the operation of the gearshift; and
to acquire display data corresponding to the switch content indicated by the gear switch information from a display data storage that stores display data of an image illustrating a transition of a vehicle state when the gear position of the vehicle is switched for each of switch patterns of the gear position, and display an image on an instrument panel of the vehicle depending on the acquired display data, wherein
the display data stored in the display data storage includes animation data for displaying three types of graphics including a before-switching graphic indicating a state of the vehicle before switching of the gear position, an after-switching graphic indicating a state of the vehicle after switching of the gear position, and a suggestion graphic suggesting that the gear position is going to be switched to the gear position after switching of the gear position in animation, each of the three types of graphics being displayed not to overlap other two of the three types of graphics, and
the processing circuitry displays each of the three types of graphics in animation depending on the animation data included in the acquired display data, and
performs determination of whether the vehicle is traveling or stopping by monitoring a speed of the vehicle, wherein
the processing circuitry displays each of the three types of graphics in animation depending on the animation data included in the acquired display data when the vehicle is determined to be stopping in the determination while changing the three types of graphics in an order of an image including the before-switching graphic, an image including the suggestion graphic, and an image including the after-switching graphic, and displays each of the three types of graphics in a still image when the vehicle is determined to be traveling in the determination while changing the three types of graphics in an order of an image including the before-switching graphic, an image including the suggestion graphic, and an image including the after-switching graphic.

2. The display control device according to claim 1, wherein when another gearshift operation is detected in the detection while an image is being displayed and another gear switch information indicating the another gearshift operation is outputted, the processing circuitry acquires another display data corresponding to a switch content indicated by the another gear switch information from the display data storage and displays an image on the instrument panel depending on said another display data.

3. The display control device according to claim 2, wherein the processing circuitry displays an image on the instrument panel depending on said another display data before the display of an image currently being displayed is completed.

4. The display control device according to claim 2, wherein the processing circuitry increases transmittance of an image currently being displayed, completes the display of the image currently being displayed, and then displays an image depending on said another display data, and decreases transmittance of an image displayed depending on the another display data to be lower than the transmittance of the image currently being displayed.

5. A display control method comprising:
detecting an operation of a gearshift of a vehicle and outputting gear switch information indicating a switch content of a gear position of the vehicle accompanying the operation of the gearshift; and
acquiring display data corresponding to the switch content indicated by the gear switch information from a display data storage that stores display data of an image illustrating a transition of a vehicle state when the gear position of the vehicle is switched for each of switch patterns of the gear position, and displaying an image on an instrument panel of the vehicle depending on the acquired display data, wherein
the display data stored in the display data storage includes animation data for displaying three types of graphics including a before-switching graphic indicating a state of the vehicle before switching of the gear position, an after-switching graphic indicating a state of the vehicle after switching of the gear position, and a suggestion graphic suggesting that the gear position is going to be switched to the gear position after switching of the gear position in animation, each of the three types of graphics being displayed not to overlap other two of the three types of graphics, and
a processing circuitry displays each of the three types of graphics in animation depending on the animation data included in the acquired display data, and
performs determination of whether the vehicle is traveling or stopping by monitoring a speed of the vehicle, and
the processing circuitry displays each of the three types of graphics in animation depending on the animation data included in the acquired display data when the vehicle is determined to be stopping in the determination while changing the three types of graphics in an order of an image including the before-switching graphic, an image including the suggestion graphic, and an image including the after-switching graphic, and displays each of the three types of graphics in a still image when the vehicle is determined to be traveling in the determination while changing the three types of graphics in an order of an image including the before-switching graphic, an image including the suggestion graphic, and an image including the after-switching graphic.
